(19) United States
(12) Patent Application Publication
(10) Pub. No.: US 2026/0111040 A1
(43) Pub. Date: Apr. 23, 2026

(54) AUTONOMOUS LINE PULLING SYSTEM

(71) Applicant: Botcrew Technologies Corporation, Duluth, MN (US)

(72) Inventor: Andrew J. Archer, Duluth, MN (US)

(21) Appl. No.: 19/360,680

(22) Filed: Oct. 16, 2025

Related U.S. Application Data
(60) Provisional application No. 63/708,674, filed on Oct. 17, 2024.

(51) Int. Cl. G05D 1/672; G05D 107/70

(52) U.S. Cl. CPC G05D 1/672; G05D 2107/75

(57) ABSTRACT

An autonomous utility vehicle can include a towing component. The vehicle can further include a fastening component attached to the towing component, and configured to fasten to a cable to be pulled by the vehicle. The vehicle can further include processor(s) coupled to a memory having instructions stored therein, which when executed by the processor(s), cause the vehicle to: detect a tension of the cable, determine whether the tension of the cable is detected, in response to determining that the tension of the cable is detected, determine whether the tension of the cable has exceeded a tension threshold, and in response to determining that the tension of the cable has exceeded the tension threshold, adjust at least one of: a speed of the vehicle or a heading of the vehicle.

### CROSS-REFERENCE TO RELATED APPLICATION

This application claims the benefit of U.S. Provisional Application No. 63/708,674 filed on Oct. 17, 2024, the disclosure of which is incorporated herein by reference in its entirety.

### TECHNICAL FIELD

Embodiments of the present disclosure relate generally to autonomous utility vehicles. More particularly, embodiments of the disclosure relate to an autonomous line pulling system using an autonomous utility vehicle.

### BACKGROUND

Utility vehicles can be used to carry out specific tasks on a variety of terrains. They are commonly used in agriculture, construction, landscaping, solar installation, and various other settings. They may be equipped with a range of attachments and accessories, such as cargo beds, plows, towing equipment, etc., making them suitable for tasks like transporting materials, hauling equipment, etc. Some utility vehicles are provided in the form of a small truck with an open back and low sides that can travel easily over rough ground. As compared to cars and trucks, utility vehicles may be built with a rugged frame and enhanced suspension to handle rough terrain and provide stability in various environments.

However, utility vehicles operated by human drivers can limit the areas within an environment in which the vehicles can be used. Solar farms are one such example environment, in which solar modules, e.g., including one or more solar panels, are mounted on supports, known as torque bars or torque tubes, and oriented for receiving sunlight to generate and/or store electricity. Torque bars/tubes and solar modules/panels can be arranged in a networked fashion over a large area to provide a solar array. However, operational constraints set by the torque bars can interfere with human-operated utility vehicles'ability to travel underneath the torque bars to run electrical cables and deliver installation components to a precise location. Such constraints can include a clearance height for the vehicle associated with the height of the torque bars, and safety hazards posed to a human operator. These concerns can sometimes require the human operator to drive the vehicle along extended paths around the perimeter/length of the torque bars, contributing inefficiencies to installation and/or maintenance operations associated with solar farms. Therefore, improved systems and methods for transporting equipment through solar farms are desirable to avoid constraints associated with the geometry of the solar arrays and human operation.

### SUMMARY

According to one aspect, the disclosure is generally directed to an autonomous utility vehicle, comprising a towing component mounted on the autonomous utility vehicle, a fastening component attached to the towing component, and configured to fasten to a cable to be pulled by the autonomous utility vehicle, and one or more processors coupled to a memory having instructions stored therein, which when executed by the one or more processors, cause the autonomous utility vehicle to detect a tension of the cable, determine whether the tension of the cable is detected, in response to determining that the tension of the cable is detected, determine whether the tension of the cable has exceeded a tension threshold, and in response to determining that the tension of the cable has exceeded the tension threshold, adjust at least one of: a speed of the autonomous utility vehicle or a heading of the autonomous utility vehicle.

According to some aspects, the instructions, which when executed by the one or more processors, further cause the autonomous utility vehicle to: determine whether the cable has been fastened, and the instructions, which when executed by the one or more processors, cause the autonomous utility vehicle to detect the tension of the cable comprises the instructions, which when executed by the one or more processors, cause the autonomous utility vehicle to: in response to determining that the cable has been fastened, detect the tension of the cable.

According to some aspects, the instructions, when executed by the one or more processors, further cause the autonomous utility vehicle to: in response to determining that the tension of the cable has not exceeded the tension threshold, maintain the speed of the autonomous utility vehicle and maintain the heading of the autonomous utility vehicle.

According to some aspects, a height of the autonomous utility vehicle is less than a height of a torque bar in a solar installation system.

According to some aspects, the autonomous utility vehicle further comprises an arm configured to grip the cable and place the cable on a cable hanger in a solar installation system.

According to some aspects, the cable is wound on a cable spool.

According to some aspects, the autonomous utility vehicle is operable in an autonomous driving mode, a manual driving mode, or a semi-autonomous driving mode.

According to some aspects, the autonomous utility vehicle is operable by a user device through a wireless communication.

According to some aspects, the autonomous utility vehicle is in communication with another autonomous utility vehicle over a network.

According to another aspect, the disclosure is generally directed to a computer-implemented method of autonomously pulling a cable for an autonomous utility vehicle, the method comprising detecting a tension of the cable, determining whether the tension of the cable is detected, in response to determining that the tension of the cable is detected, determining whether the tension of the cable has exceeded a tension threshold, and in response to determining that the tension of the cable has exceeded the tension threshold, adjusting at least one of: a speed of the autonomous utility vehicle or a heading of the autonomous utility vehicle.

According to some aspects, the method further comprises: determining whether the cable has been fastened, and detecting the tension of the cable comprises: in response to determining that the cable has been fastened, detecting the tension of the cable.

According to some aspects, the method further comprises, in response to determining that the tension of the cable has not exceeded the tension threshold, maintaining the speed of the autonomous utility vehicle and the heading of the autonomous utility vehicle.

According to some aspects, adjusting the speed of the autonomous utility vehicle comprises: increasing or decreasing the speed of the autonomous utility vehicle.

### BRIEF DESCRIPTION OF THE DRAWINGS

Embodiments of the invention are illustrated by way of example and not limitation in the figures of the accompanying drawings in which like references indicate similar elements.

FIGS. 1A-1B are diagrams illustrating an autonomous line or cable pulling system accordingly to an embodiment.

FIG. 2 is a diagram illustrating the tension of the cables being pulled.

FIGS. 3A-3B are block diagrams illustrating an autonomous utility vehicle system according to an embodiment.

FIG. 4 is a block diagram illustrating an example of an autonomous utility vehicle according to an embodiment.

FIG. 5 is a diagram illustrating an autonomous utility vehicle operating under torque bars.

FIG. 6 is a diagram illustrating an autonomous utility vehicle operating with cable hangers.

FIG. 7 is a flow diagram illustrating a process of autonomously pulling a cable according to an embodiment.

FIG. 8 is a block diagram illustrating a data processing system according to one embodiment.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to one aspect, an autonomous utility vehicle is provided. The autonomous utility vehicle can include a towing component mounted on the autonomous utility vehicle. The autonomous utility vehicle can further include a fastening component attached to the towing component, and configured to fasten to a cable to be pulled by the autonomous utility vehicle. The autonomous utility vehicle can further include one or more processors coupled to a memory having instructions stored therein, which when executed by the processor(s), cause the autonomous utility vehicle to: detect a tension of the cable, determine whether the tension of the cable is detected, in response to determining that the tension of the cable is detected, determine whether the tension of the cable has exceeded a tension threshold, and in response to determining that the tension of the cable has exceeded the tension threshold, adjust at least one of: a speed of the autonomous utility vehicle or a heading of the autonomous utility vehicle.

According to another aspect, a computer-implemented method of autonomously pulling a cable for an autonomous utility vehicle is provided. The method can include detecting a tension of the cable; determining whether the tension of the cable is detected; in response to determining that the tension of the cable is detected, determining whether the tension of the cable has exceeded a tension threshold; and in response to determining that the tension of the cable has exceeded the tension threshold, adjusting at least one of: a speed of the autonomous utility vehicle or a heading of the autonomous utility vehicle.

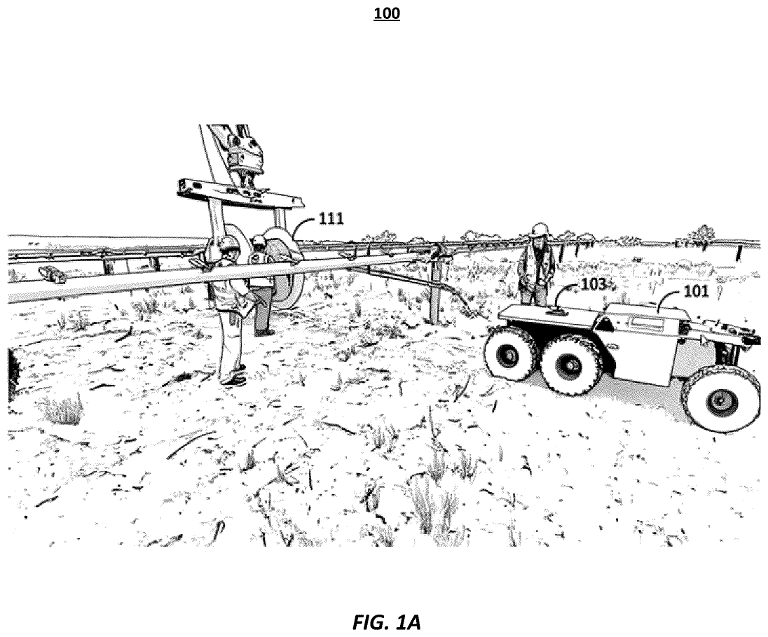

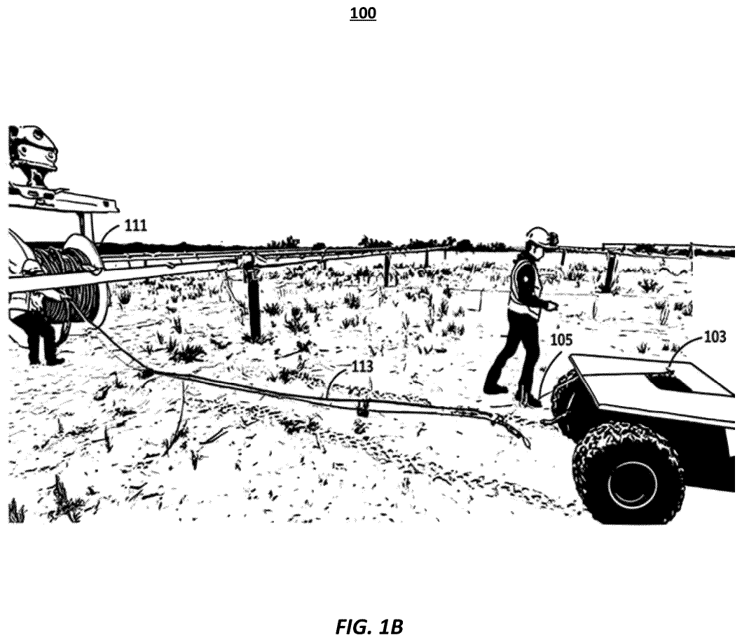

FIGS. 1A-1B are diagrams illustrating an autonomous line or cable pulling system accordingly to an embodiment. Referring to FIGS. 1A-1B, system 100 may include, but is not limited to, an autonomous or robotic utility vehicle 101 and a cable spool 111 that carries electrical cables 113. In an embodiment, utility vehicle 101 may include a towing component 103 (e.g., a hitch) mounted on its cargo bed. As shown in FIG. 1B, a cable 105 (or other suitable fastening components) may be attached to the towing component 103 and used to pull the cables 113 from cable spool 111. Cable 105 may be fastened to electrical cables 113 via any suitable fastening mechanisms to ensure a secure pulling process.

In FIGS. 1A-1B, the utility vehicle 101 is shown as being used to pull electrical cables 113 from a large cable spool for solar array installation in a solar farm. Note, however, that this is merely an example application and that the utility vehicle 101 can be used to pull any type of cable within any environment.

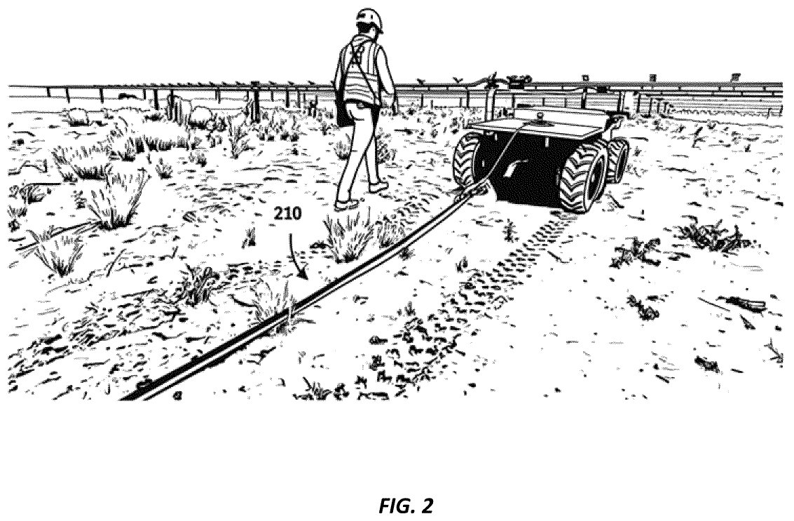

Referring now to FIG. 2, which is a diagram illustrating the tension of cables 113, as utility vehicle 101 pulls the cables 113 from cable spool 111, tension 210 in cables 113 can increase. Note that the tension in cables 113 is a function of a number of factors. For example, friction forces are a function of the length of cables 113 being pulled, the materials from which the cables 113 are constructed, weight of the cables 113, the number of curves or bends in the travel path of the utility vehicle 101, etc. The curves or bends can affect the tension 210 a great amount as the friction forces around them can be much higher than the straight portions of the travel path.

Based on the tension 210 detected in cables 113, utility vehicle 101 can adjust its speed and/or heading accordingly such that the cables 113 do not get entangled or stuck around the spool 111, which can damage the spool 111 and/or cables 113. For example, when utility vehicle 101 detects that the tension 210 in cables 113 has exceeded a certain tension threshold (e.g., a predetermined tension threshold), utility vehicle 101 may decrease its pulling speed and/or adjust its heading to decrease tension 210. Otherwise, utility vehicle 101 may maintain its pulling speed and/or heading to continue carrying out the pulling process.

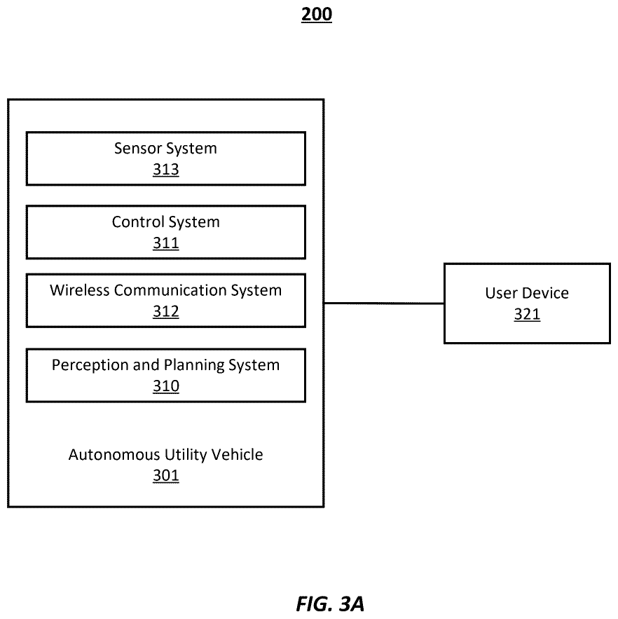

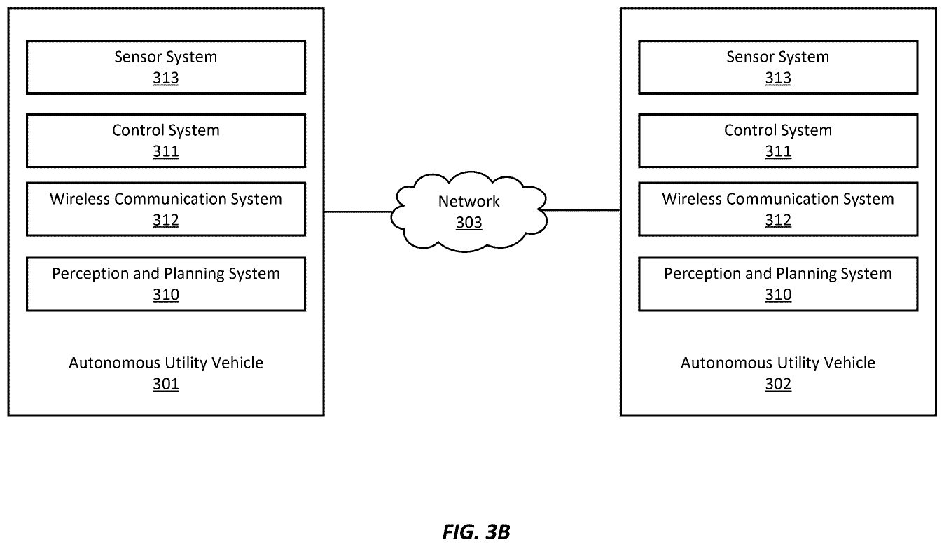

FIG. 3A is a block diagram illustrating an autonomous utility vehicle system according to an embodiment. Referring to FIG. 3A, system 300 includes autonomous or robotic utility vehicle 301 that is communicatively coupled to a user device 321. In some embodiments, utility vehicle 301 may be the utility vehicle 101 of FIGS. 1A-1B.

User device 321 can be used by a human operator to control or operate the utility vehicle 301 when the vehicle is operating in manual or semi-autonomous mode. For example, the human operator may use the device 321 to drive the vehicle 301 by controlling the vehicle's speed (e.g., brake and throttle) and heading (e.g., steering). User device 321 may be a remote control, a desktop, a laptop, a tablet, a server, a mobile phone, etc.

Utility vehicle 301 can be a vehicle that is configured to operate in an autonomous mode in which the utility vehicle navigates through an environment (e.g., solar farm, construction site, etc.) with little or no input from a human driver. Such an autonomous utility vehicle can include a sensor system having one or more sensors that are configured to detect information about the environment in which the utility vehicle operates. The utility vehicle and its associated controller(s) can use the detected information to navigate through the environment. Utility vehicle 301 can operate in a manual mode, a full autonomous mode, or a partial (semi) autonomous mode.

In one embodiment, utility vehicle 301 includes, but is not limited to, perception and planning system 310, vehicle control system 311, wireless communication system 312, and sensor system 313. Utility vehicle 301 may further include certain common components included in ordinary vehicles, such as, an engine, wheels, steering wheel, transmission, etc., which may be controlled by vehicle control system 311 and/or perception and planning system 310 using a variety of communication signals and/or commands, such as, for example, acceleration signals or commands, deceleration signals or commands, steering signals or commands, braking signals or commands, etc.

Components 310-313 may be communicatively coupled to each other via an interconnect, a bus, a network, or a combination thereof. For example, components 310-313 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

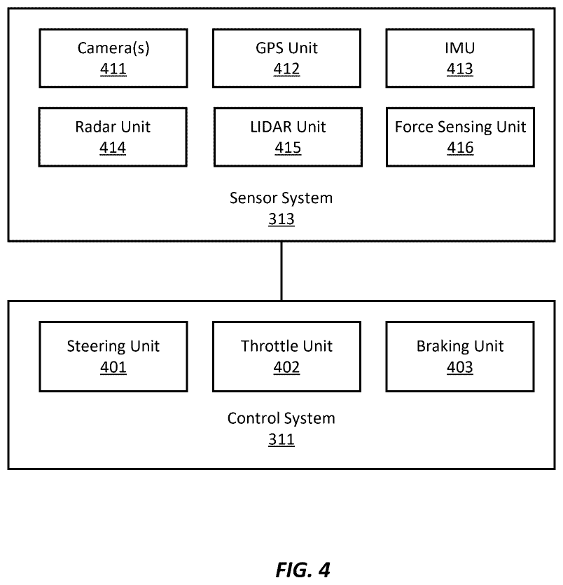

Referring now to FIG. 4, in one embodiment, sensor system 313 includes, but it is not limited to, one or more cameras 411, global positioning system (GPS) unit 412, inertial measurement unit (IMU) 413, radar unit 414, and a light detection and range (LIDAR) unit 415, and force sensing unit 416. GPS system 412 may include a transceiver operable to provide information regarding the position of the autonomous utility vehicle. IMU unit 413 may sense position and orientation changes of the autonomous vehicle based on inertial acceleration. Radar unit 414 may represent a system that utilizes radio signals to sense objects within the local environment of the autonomous utility vehicle. In some embodiments, in addition to sensing objects, radar unit 414 may additionally sense the speed and/or heading of the objects. LIDAR unit 415 may sense objects in the environment in which the autonomous utility vehicle is located using lasers. LIDAR unit 415 may include one or more laser sources, a laser scanner, and one or more detectors, among other system components. Cameras 411 may include one or more devices to capture images of the environment surrounding the utility vehicle. Cameras 411 may be still cameras and/or video cameras. A camera may be mechanically movable, for example, by mounting the camera on a rotating and/or tilting a platform. In an embodiment, force sensing unit 416 may include one or more force sensors to measure the applied force on the utility vehicle. Thus, force sensing unit 416 can be used to measure the tension of an object (e.g., a cable) being pulled by the utility vehicle.

Sensor system 313 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the utility vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 311 includes, but is not limited to, steering unit 401, throttle unit 402 (also referred to as an acceleration unit), and braking unit 403.

Steering unit 401 serves to adjust the direction or heading of the vehicle. Throttle unit 402 is to control the speed of the motor or engine that in turn control the speed and acceleration of the vehicle. Braking unit 403 is to decelerate the vehicle by providing friction to slow the wheels or tires of the vehicle. Note that the components as shown in FIG. 4 may be implemented in hardware, software, or a combination thereof.

Referring back to FIG. 3A, wireless communication system 312 serves to allow communication between utility vehicle 301 and external systems, such as devices, sensors, other vehicles, etc. For example, referring to FIG. 3B, wireless communication system 312 can wirelessly communicate with one or more other autonomous utility vehicles (e.g., vehicle 302) via a communication network, such as network 303. Network 303 may be any type of networks such as a local area network (LAN), a wide area network (WAN) such as the Internet, a cellular network, a satellite network, or a combination thereof, wired or wireless. Wireless communication system 312 can use any cellular communication network or a wireless local area network (WLAN), e.g., using WiFi to communicate with another component or system. Wireless communication system 312 can communicate directly with a device (e.g., user device 321), for example, using an infrared link, Bluetooth, etc.

Some or all of the functions of autonomous utility vehicle 301 may be controlled or managed by perception and planning system 310, especially when operating in an autonomous driving mode. Perception and planning system 310 includes the necessary hardware (e.g., processor(s), memory, storage) and software (e.g., operating system, planning and routing programs) to receive information from sensor system 313, control system 311, and/or wireless communication system 312, process the received information, plan a route or path from a starting point to a destination point within an environment (e.g., solar farm, construction site, etc.), and then drive vehicle 301 based on the planning and control information. Alternatively, perception and planning system 310 may be integrated with vehicle control system 311.

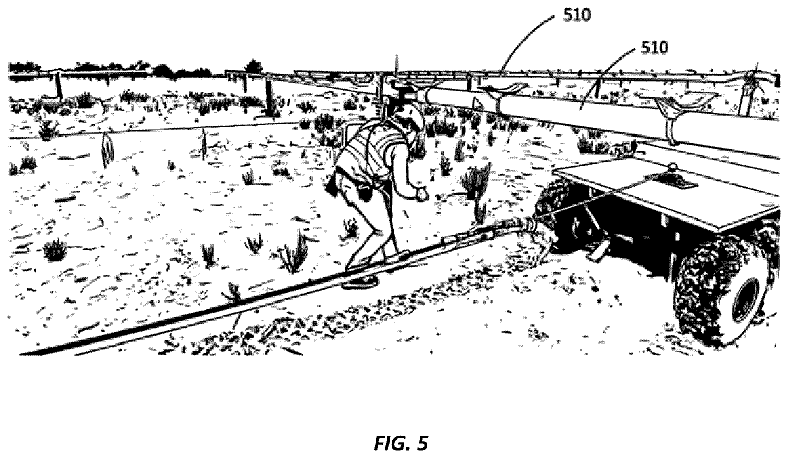

FIG. 5 is a diagram illustrating an autonomous utility vehicle operating under torque bars according to an embodiment. As shown, the utility vehicle (e.g., utility vehicle 101 of FIG. 1A) is operating within a solar farm having rows of torque bars 510 (also referred to as torque tubes) installed, for example, about four to five feet from ground. The torque bars are generally large, horizontal structural bars or tubes that connect to solar modules or panels to provide stability and support to the solar modules and provide a channel for routing cables (e.g., cables 113 of FIG. 1A) to the solar modules.

As shown, the autonomous or robotic utility vehicle does not include a side-by-side seating arrangement of a conventional utility vehicle to seat a human driver. Thus, the robotic utility vehicle can be implemented with a low height profile such that the height of the vehicle is less than the height of each torque bar 510. In some embodiments, such height can be about 5 feet, though torque bars 510 could be provided at a different height without departing from the disclosure. As such, the unmanned, robotic utility vehicle can freely maneuver underneath the torque bars 510 without a human driver, whereas a conventional utility vehicle cannot do so due to the safety of its human driver. This way, the installation process of the solar modules can be expedited to increase its efficiency.

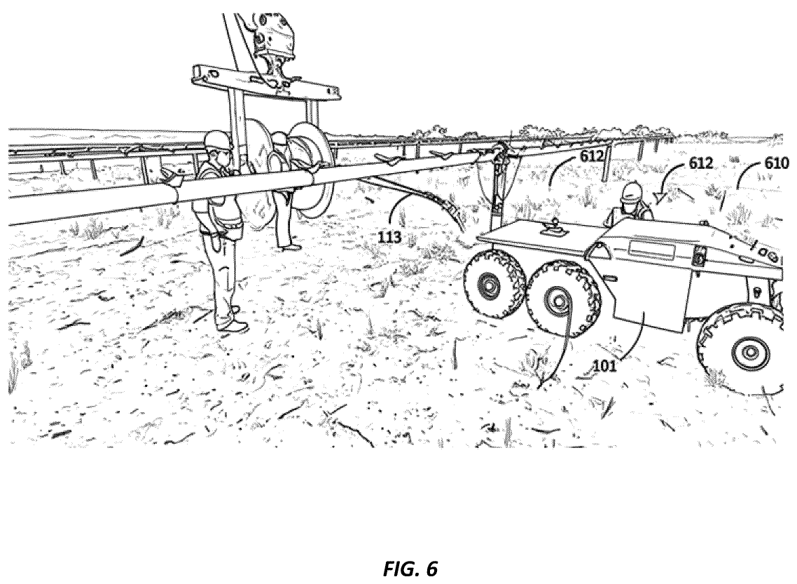

FIG. 6 is a diagram illustrating an autonomous utility vehicle operating with cable hangers according to an embodiment. As shown in FIG. 6, cable hangers 612 are disposed underneath the torque bars and are located on the side of autonomous utility vehicle 101. Cable hangers 612 may be used to organize, support and route the cables 113. The cable hangers 612 may be supported by a guiding line or cable 610. Although not shown in FIG. 6, in some embodiments, vehicle 101 may include an arm mounted on one or both sides of the vehicle for gripping and placing the cables 113 onto the cable hangers 612 while pulling the cables 113. This way, the cables can be organized and routed without human intervention, thereby increasing the efficiency of the solar system installation process.

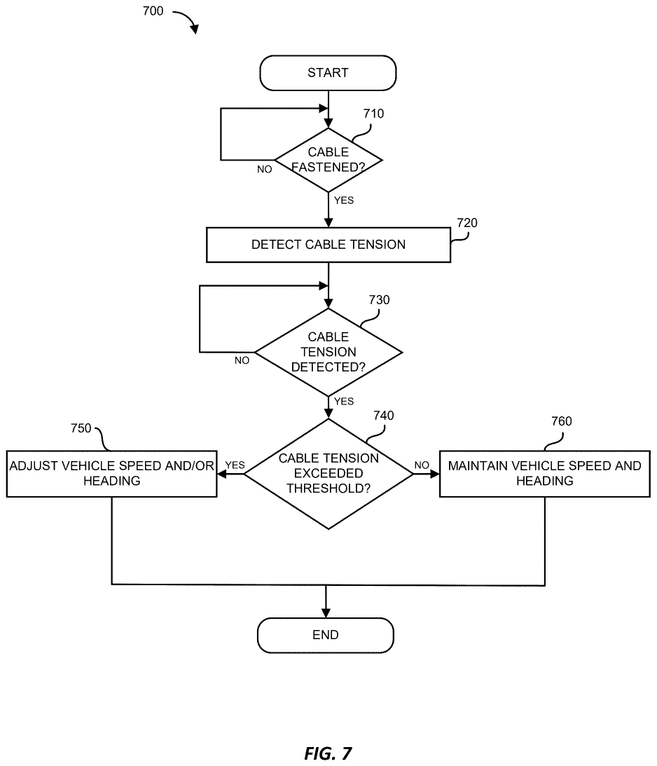

FIG. 7 is a flow diagram illustrating a process of autonomously pulling a cable according to an embodiment. Process 700 may be performed by processing logic which may include software, hardware, or a combination thereof. For example, process 700 may be performed by the control system 311 of FIG. 3A. Referring to FIG. 7, at block 710, the processing logic may determine whether a to-be-pulled cable (e.g., cables 113 of FIG. 1B) has been fastened to an autonomous utility vehicle (e.g., vehicle 101 of FIG. 1A). If so, at block 720, the processing logic may detect the tension of the cable. Otherwise, the process logic returns to block 710.

At block 730, the processing logic may determine whether the tension of the cable has been detected. If so, the processing logic proceeds to block 740 to determine whether the tension of the cable has exceeded a tension threshold (e.g., a predetermined threshold).

Otherwise, the processing logic returns to block 730.

If it is determined that the tension of the cable has exceeded the tension threshold, the processing logic proceeds to block 750 where the processing logic may adjust (e.g., increase or decrease) the speed of the vehicle and/or adjust the heading or direction of the vehicle. Otherwise, if the tension is equal to or less than the tension threshold, the processing logic proceeds to block 760 where the processing logic may maintain the speed and heading of the vehicle.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

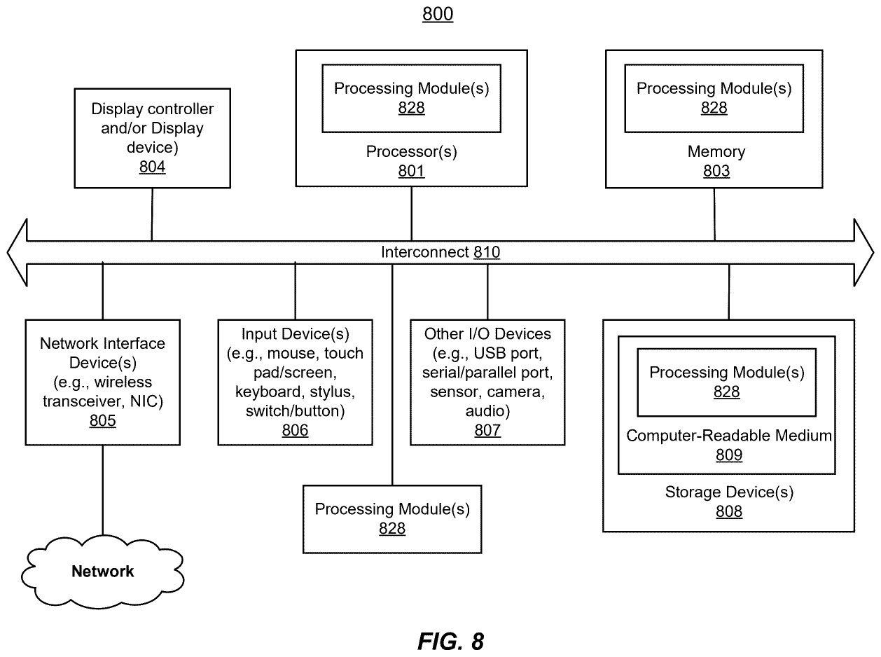

FIG. 8 is a block diagram illustrating an example of a data processing system which may be used with an embodiment of the disclosure. For example, system 800 may represent any of data processing systems described above performing any of the processes or methods described above, such as, for example, control system 311 and sensor system 313 of FIG. 3A. System 800 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 800 is intended to show a high level view of many components of the computer system. However, it is to be understood that additional components may be present in certain implementations and furthermore, different arrangement of the components shown may occur in other implementations. System 800 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 800 includes processor 801, memory 803, and devices 805-808 via a bus or an interconnect 810. Processor 801 may represent a single processor or multiple processors with a single processor core or multiple processor cores included therein. Processor 801 may represent one or more general-purpose processors such as a microprocessor, a central processing unit (CPU), or the like. More particularly, processor 801 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 801 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 801, which may be a low power multi-core processor socket such as an ultra-low voltage processor, may act as a main processing unit and central hub for communication with the various components of the system. Such processor can be implemented as a system on chip (SoC). Processor 801 is configured to execute instructions for performing the operations and steps discussed herein. System 800 may further include a graphics interface that communicates with optional graphics subsystem 804, which may include a display controller, a graphics processor, and/or a display device.

Processor 801 may communicate with memory 803, which in one embodiment can be implemented via multiple memory devices to provide for a given amount of system memory. Memory 803 may include one or more volatile storage (or memory) devices such as random access memory (RAM), dynamic RAM (DRAM), synchronous DRAM (SDRAM), static RAM (SRAM), or other types of storage devices. Memory 803 may store information including sequences of instructions that are executed by processor 801, or any other device. For example, executable code and/or data of a variety of operating systems, device drivers, firmware (e.g., input output basic system or BIOS), and/or applications can be loaded in memory 803 and executed by processor 801. An operating system can be any kind of operating systems, such as, for example, Robot Operating System (ROS), Windows® operating system from Microsoft®, Mac OS®/iOS® from Apple, Android® from Google®, LINUX, UNIX, or other real-time or embedded operating systems.

System 800 may further include IO devices such as devices 805-808, including network interface device(s) 805, optional input device(s) 806, and other optional IO device(s) 807. Network interface device 805 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 806 may include a mouse, a touch pad, a touch sensitive screen (which may be integrated with display device 804), a pointer device such as a stylus, and/or a keyboard (e.g., physical keyboard or a virtual keyboard displayed as part of a touch sensitive screen). For example, input device 806 may include a touch screen controller coupled to a touch screen. The touch screen and touch screen controller can, for example, detect contact and movement or break thereof using any of one or more touch sensitivity technologies, including but not limited to capacitive, resistive, infrared, and surface acoustic wave technologies, as well as other proximity sensor arrays or other elements for determining one or more points of contact with the touch screen.

IO devices 807 may include an audio device. An audio device may include a speaker and/or a microphone to facilitate voice-enabled functions, such as voice recognition, voice replication, digital recording, and/or telephony functions. Other IO devices 807 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 807 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 810 via a sensor hub (not shown), while other devices such as a keyboard or thermal sensor may be controlled by an embedded controller (not shown), dependent upon the specific configuration or design of system 800.

To provide for persistent storage of information such as data, applications, one or more operating systems and so forth, a mass storage (not shown) may also couple to processor 801. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 801, e.g., via a serial peripheral interface (SPI). This flash device may provide for non-volatile storage of system software, including BIOS as well as other firmware of the system.

Storage device 808 may include computer-accessible storage medium 809 (also known as a machine-readable storage medium or a computer-readable medium) on which is stored one or more sets of instructions or software (e.g., module, unit, and/or logic 828) embodying any one or more of the methodologies or functions described herein. Processing module/unit/logic 828 may also reside, completely or at least partially, within memory 803 and/or within processor 801 during execution thereof by data processing system 800, memory 803 and processor 801 also constituting machine-accessible storage media. Processing module/unit/logic 828 may further be transmitted or received over a network via network interface device 805.

Computer-readable storage medium 809 may also be used to store some software functionalities described above persistently. While computer-readable storage medium 809 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Processing module/unit/logic 828, components and other features described herein can be implemented as discrete hardware components or integrated in the functionality of hardware components such as ASICS, FPGAs, DSPs or similar devices. In addition, processing module/unit/logic 828 can be implemented as firmware or functional circuitry within hardware devices. Further, processing module/unit/logic 828 can be implemented in any combination hardware devices and software components.

Note that while system 800 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that includes hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An autonomous utility vehicle, comprising:
a towing component mounted on the autonomous utility vehicle;
a fastening component attached to the towing component, and configured to fasten to a cable to be pulled by the autonomous utility vehicle; and
one or more processors coupled to a memory having instructions stored therein, which when executed by the one or more processors, cause the autonomous utility vehicle to:
detect a tension of the cable;
determine whether the tension of the cable is detected;
in response to determining that the tension of the cable is detected, determine whether the tension of the cable has exceeded a tension threshold; and
in response to determining that the tension of the cable has exceeded the tension threshold, adjust at least one of: a speed of the autonomous utility vehicle or a heading of the autonomous utility vehicle.

2. The autonomous utility vehicle of claim 1, wherein:
the instructions, which when executed by the one or more processors, further cause the autonomous utility vehicle to: determine whether the cable has been fastened; and
the instructions, which when executed by the one or more processors, cause the autonomous utility vehicle to detect the tension of the cable comprises the instructions, which when executed by the one or more processors, cause the autonomous utility vehicle to: in response to determining that the cable has been fastened, detect the tension of the cable.

3. The autonomous utility vehicle of claim 1, wherein the instructions, which when executed by the one or more processors, further cause the autonomous utility vehicle to: in response to determining that the tension of the cable has not exceeded the tension threshold, maintain the speed of the autonomous utility vehicle and maintain the heading of the autonomous utility vehicle.

4. The autonomous utility vehicle of claim 1, wherein a height of the autonomous utility vehicle is less than a height of a torque bar in a solar installation system.

5. The autonomous utility vehicle of claim 1, further comprising an arm configured to grip the cable and place the cable on a cable hanger in a solar installation system.

6. The autonomous utility vehicle of claim 1, wherein the cable is wound on a cable spool.

7. The autonomous utility vehicle of claim 1, wherein the autonomous utility vehicle is operable in an autonomous driving mode, a manual driving mode, or a semi-autonomous driving mode.

8. The autonomous utility vehicle of claim 1, wherein the autonomous utility vehicle is operable by a user device through a wireless communication.

9. The autonomous utility vehicle of claim 1, wherein the autonomous utility vehicle is in communication with another autonomous utility vehicle over a network.

10. A computer-implemented method of autonomously pulling a cable for an autonomous utility vehicle, the method comprising:
detecting a tension of the cable;
determining whether the tension of the cable is detected;
in response to determining that the tension of the cable is detected, determining whether the tension of the cable has exceeded a tension threshold; and
in response to determining that the tension of the cable has exceeded the tension threshold, adjusting at least one of: a speed of the autonomous utility vehicle or a heading of the autonomous utility vehicle.

11. The method of claim 10, wherein:
the method further comprises: determining whether the cable has been fastened; and
detecting the tension of the cable comprises: in response to determining that the cable has been fastened, detecting the tension of the cable.

12. The method of claim 10, further comprising:
in response to determining that the tension of the cable has not exceeded the tension threshold, maintaining the speed of the autonomous utility vehicle and the heading of the autonomous utility vehicle.

13. The method of claim 10, wherein adjusting the speed of the autonomous utility vehicle comprises: increasing or decreasing the speed of the autonomous utility vehicle.

14. The method of claim 10, wherein the autonomous utility vehicle comprises a towing component mounted on the autonomous utility vehicle, and a fastening component attached to the towing component and configured to fasten to the cable, wherein the cable is to be pulled by the autonomous utility vehicle.

15. The method of claim 14, wherein the autonomous utility vehicle further comprises an arm configured to grip the cable and place the cable on a cable hanger in a solar installation system.

16. The method of claim 10, wherein a height of the autonomous utility vehicle is less than a height of a torque bar in a solar installation system.

17. The method of claim 10, wherein the cable is wound on a cable spool.

18. The method of claim 10, wherein the autonomous utility vehicle is operable in an autonomous driving mode, a manual driving mode, or a semi-autonomous driving mode.

19. The method of claim 10, wherein the autonomous utility vehicle is operable by a user device through a wireless communication.

20. The method of claim 10, wherein the autonomous utility vehicle is in communication with another autonomous utility vehicle over a network.
